(19) United States
(12) Patent Application Publication
(10) Pub. No.: US 2006/0140160 A1
(43) Pub. Date: Jun. 29, 2006

(54) Method for detecting multi-user behavior of an aerial interface in gprs and egprs mobile radio system

(75) Inventors: Guldo Vendel, Bonn (DE); Aldullah Cam, Koenigswinter (DE); Andreas Neusinger, Unkel (DE); Joachim Riedel, Bonn (DE)

Correspondence Address: NORRIS, MCLAUGHLIN & MARCUS, 875 THIRD AVE, 18TH FLOOR, NEW YORK, NY, 10022, US

(73) Assignee: T-MOBILE DEUTSCHLAND GmbH, Bonn (DE)

(21) Appl. No.: 10/538,241

(22) PCT Filed: Dec. 9, 2003
(86) PCT No.: PCT/DE03/04055

§ 371 Date: Nov. 16, 2005

(30) Foreign Application Priority Data
Dec. 9, 2002 (DE) 102 57 630.0

(51) Int. Cl. H04B 7/212

(52) U.S. Cl. 370/337; 370/349

(57) ABSTRACT

Method and apparatus for detecting multiuser behavior on the aerial interface in GPRS and EGPRS mobile radio systems, wherein during a transmission of subscriber data on the aerial interface, additional information contained in the subscriber data are acquired and evaluated by a device on the network side and/or the subscriber side, both in the uplink and the downlink. The number of parallel subscribers on used time slots can be identifies on the basis of the additional information located in the radio control blocks.

The invention relates to a method for detecting on the subscriber side or on the network side multiuser behavior on an aerial interface in GPRS and EGPRS mobile radio system.

GPRS is an abbreviation for General Packet Radio Service (EGPRS: Enhanced GPRS) and enables for the first time GSM mobile radio network operators to offer packet-based data services without permanently allocating resources of the aerial interface. GPRS supports many data transmission protocols of the higher-level OSI layers, for example IP and X.25. This enables the mobile radio subscriber to communicate with external data networks, for example the Internet and intranets inside companies. GPRS can allocate a single transmission channel (i.e., timeslot) to several subscribers. Likewise, several timeslots can be allocated to a single subscriber for data transmission. The data to be transmitted are divided into packets (i.e., RLC blocks) and transmitted over the channel(s). With GPRS, the transmission capacity is shared by all GPRS subscribers of a radio cell. Special protocols in the radio link are responsible for preventing collisions in the channel during packet allocation and for allocating the transmission capacity to the various subscribers. The BSS manufacturers employ functions developed by ETSI as well as additionally proprietary functions.

Generally, for a more detailed discussion of GPRS and EGPRS, reference is made to the published ETSI specifications applicable at the time of the filing for this patent.

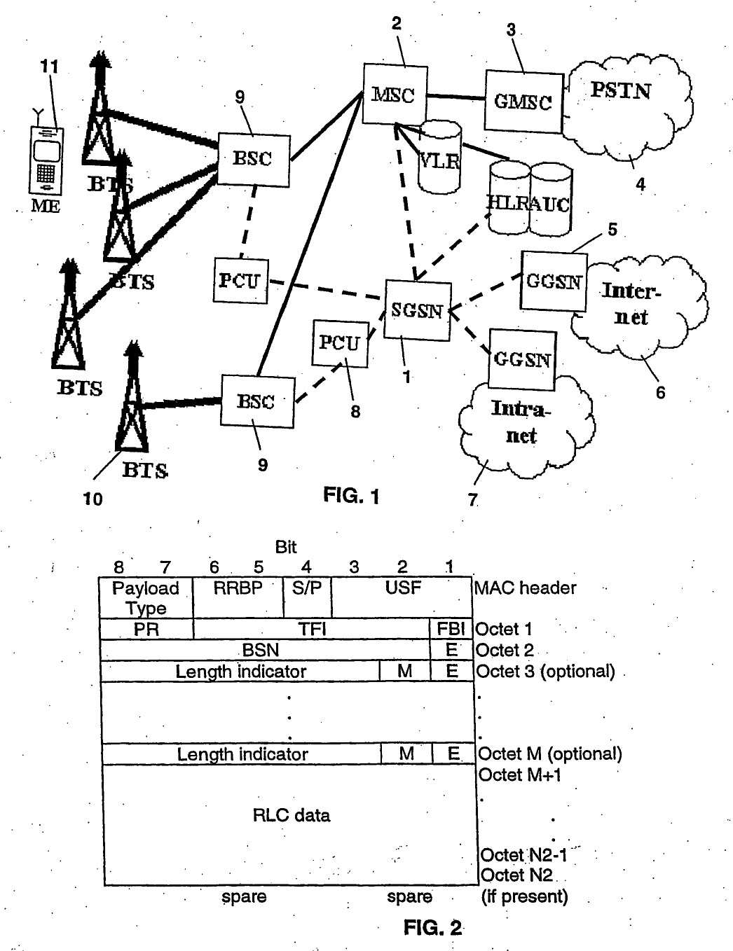

FIG. 1 shows the architecture of a GPRS-enabled mobile communication network. The GPRS system is based on the so-called GPRS Support Nodes (GSN), which are responsible for packet switching and operate as a gateway to other packet networks, such as the Internet 6 or Internet 7. The GSN's are also responsible for mobility management, i.e., for identifying and monitoring the location of the subscribers. The GSN is subdivided into the SGSN and the GGSM. The Serving GPRS Support Note (SGSN) 1 is, inter alia, also responsible for mobility management and performs for packet data services a function similar to that of the Mobile Switching Center (MSC) 2 for the connection-enabled voice signals. The SGSN can be connected to the MSC via the GS interface as an optional interface. The MSC is connected via the Gateway Mobile Switching Center (GMSC) 3, for example, with the public switched telephone network (PSTN) 4. The Gateway GPRS Support Node (GGSN) 5 performs, as a gateway, in GPRS networks the function of coordinating the data traffic between external packet-switching transmission networks 6, 7 and the switching network of the mobile radio network. The SGSN 1 and the GGSN 5 communicate via an IP backbone. The SGSN 1 sets up the data communication with the radio network section. To accomplish this, the SGSN communicates via a Frame Relay network with the Packet Control Units (PCU) 8. The PCU 8 represents the GPRS-portion added in the BSS, transmitting data to and receiving data from the Based Station Controller (BSC) 9. The BSC 9 is already a component of the conventional GSM network and establishes communication with the base stations (BTS) 10. It is the main mission of the BSC 9 to generally administer the radio resources of the connected cells, whereby an internal resource manager, in conjunction with corresponding internal signaling means, allocates the required circuit-switched and packet-switched resources according to the requirements (=traffic demand), the available capacity and the applicable rules. Conventional “voice data” (circuit-switched) from a mobile radio terminal (ME) 11 are then transported from the BSC 9 to the MSC 2 (solid connecting lines). Packet data are transported from BSC 9 to SGSN1 via the PCU 8 (dashed connecting lines). The PCU 8 has to satisfy two core functions for a coordinated packet data traffic for radio transmission, which are implemented by the MAC and the RLC protocol layer. The RLC layer (Radio Link Control) segments the data packets, which arrive from the SGSN 1 for the downlink and from ME for the uplink, into several smaller sub-packets for transmission on the aerial interface, so that the data packets can be converted into the required format (segmentation of the LLC frames into RLC blocks). These smaller sub-packets are reassembled at the receiver into data packets (reassembly of the RLC blocks into LLC frames). All sub-packets are consecutively numbered to enable the receiver to assemble the sub-packets again in the proper order. The MAC protocol layer (Medium Access Control) controls access to the radio channel and allocation of the GPRS radio resources to several subscribers. In addition, the MAC layer also controls radio channel access and allocation of the GPRS radio resources to several subscribers. Moreover, the MAC layer also controls termination of the radio resource allocation for a GPRS subscriber.

Commensurate with the existing specifications, the quality of the offered GPRS service is defined and measured by several features. One of these features is the achieved throughput (bit rate) during data transmission.

In general, the entire transmission path has to be taken into consideration for the data throughput:
starting at the (Internet) server and the Internet
via the PSS with the GSN elements and the transmission paths
via the BSS with the PCU and the transmission paths
to the mobile end system (ME)

In a mobile radio network, the transmission path of the aerial interface, i.e., from the BTS to the ME, is of particular importance.

The throughput on the aerial interface is affected by several quantities:
by the multislot class (MSK) of the ME, i.e., the maximum data rate supported by the terminal in receive and transmit direction,
by the transmission capacity supplied by the provider,
in general, by the employed channel coding scheme, which is determined by the existing C/I ratio and the system-intrinsic decision threshold for a change of the protocol in particular situations,
by the system-intrinsic allocation methods of the resource aerial interface, and
if this resource is provided to a single subscriber or must be shared with other subscribers (multiuser behavior)

Modern measurement, evaluation, and rating systems, subsequently referred to simply as measurement systems, allow conclusions relating to the used channel coding scheme and the number of the used timeslots. However, today's measurement systems lack the option of evaluating the multiuser behavior on the transmission channels (timeslots).

It is therefore an object of the invention to provide a method for detecting multiuser behavior on the aerial interface in (E)GPRS mobile radio systems, which is capable of identifying and evaluating multiuser behavior in the timeslots.

This object is solved with the invention by the features of claim 1.

Advantageous embodiments and modifications of the invention are recited in the dependent claims.

The basic principle of the proposed solution is that during transmission or reception of the subscriber data, the measurement systems collect and evaluate information on the aerial interface which allows conclusions about the multiuser behavior.

For a detailed evaluation, different mechanisms must be applied for uplink (UL) and downlink (DL), depending if the system is viewed from the subscriber side or from the network side.

The proposal is based on the basic concept of comparing the number of actually used RLC blocks with the number of potentially available and hence usable RLC blocks, and to identify the number of other (parallel) subscribers in the used timeslots (for the subscriber side, for example based on the additional information contained in the RLC blocks), at the beginning of the TBF (Temporary Blocks Flow), i.e., at the beginning of the transmission of packet data between the subscriber terminal and the PCU.

Unless noted otherwise, the term “RLC-Blocks” hereinafter describes the category of the RLC data blocks as well as the category of the RLC/MAC control blocks.

It should also be noted that cells can change during mobile data transfer. Therefore, the evaluation must be performed, on one hand, for each TFB, and on the other hand, as aggregation/combination of all TBF's that participate in the transfer.

Due to the possible multislot operation of the measurement system, the measurement and evaluation modalities have to be designed accordingly.

The following description is organized in relation to the subscriber side and to the network side.

Subscriber Side

Method for the Uplink

The network side assigns the resource RLC blocks to the subscribers. Two different methods are employed: the static and the dynamic allocation method; however, the dynamic allocation method is most commonly used.

With the dynamic allocation method, the ME is informed via the so-called Uplink State Flag (USF) in the DL-RLC blocks, which UL-RLC blocks the respective ME is allowed to use. This USF is listed in the MAC header of each DL-RCL data block and DL-RLC/MAC control block, which the mobile terminating systems must evaluate until all UL data have been transmitted.

The USF is associated with the TBF, which is identified by the TFI, and hence also with the ME/subscriber in the so-called TBF Establishment Process.

The subscriber-side measurement systems must determine at the beginning of the TBF, relative to the used timeslots, if all UL-RLC blocks were occupied only by that TBF until its end, or if other subscribers also used these UL-RLC blocks. The number of parallel, i.e., simultaneous ME/subscribers can then be determined from the number of different USF's, allowing a conclusion about the multiuser behavior. This determination can also indicate the potential throughput.

With static allocation methods, an allocation is made by the message PACKET_UL_ASSIGNMENT. Accordingly, this method can estimate the usage of the timeslots only by counting the RLC blocks.

Method for the Downlink

The network side also allocates the resources for the DL, using different methods of the respective BSS manufacturer. Again, TBF and TFI are allocated within the context of the TBF Establishment Process. The TFI is used for detecting the multiuser behavior in the downlink. The TFI is part of the DL-RLC header or the DL-RLC/MAC control block.

The subscriber-side measurement systems have to determine again from the beginning of the TBF to the data transmission, if all DL-RLC blocks are used solely by this TFB/TFI, or not. This must be done for each used timeslot. This determination can again allow conclusions about the multiuser behavior.

In general, the same basic principles apply to EGPRS as well as to GPRS. The EGPRS data blocks include a RLC/MAC header which includes the corresponding information. Unlike with GPRS, however, the header formats and header types with EGPRS are different depending on the employed modulation and coding scheme.

Network Side

Because BSC and PCU allocate resources on the aerial interface for both the uplink and the downlink, specific information with respect to
the number of subscribers (TBF/TFI),
the allocation to the RLC blocks, and
the number and the allocation of the used transmission channels/timeslots
is generally known.

A network-side measurement system must for each TBF/TFI combine the available specific information into all-inclusive information with respect to the issues relating to a multiuser operation for the respective TBF/TFI. The same methods and processes are used for the uplink and the downlink.

The methods and processes known to date, as used for measuring and evaluating the quality and for analyzing potential system errors, have been inconclusive when assessing if the individual data throughput is reduced because several ME/subscribers simultaneously use the resource “timeslot.”

Conversely, by implementing the methods of the invention (both separately for each side and in combination) and by using these novel analytical techniques for evaluation, it could be directly demonstrated, where a reasonable increase in the capacity can significantly improve the quality for the subscriber in an efficient and demand-driven manner.

The quality analysis can be further improved, e.g., through combinations with other evaluation methods, for example, through a combination with the channel coding scheme used in all LC data blocks, or with the measured receive level.

The invention will be described hereinafter with reference to the drawings. Additional features, advantages and applications of the invention can be inferred from the drawings and the corresponding description.

It is shown in:

FIG. 1 an architecture of a GSM-GPRS network;

FIG. 2 a format of a GPRS downlink RLC data block with MAC header;

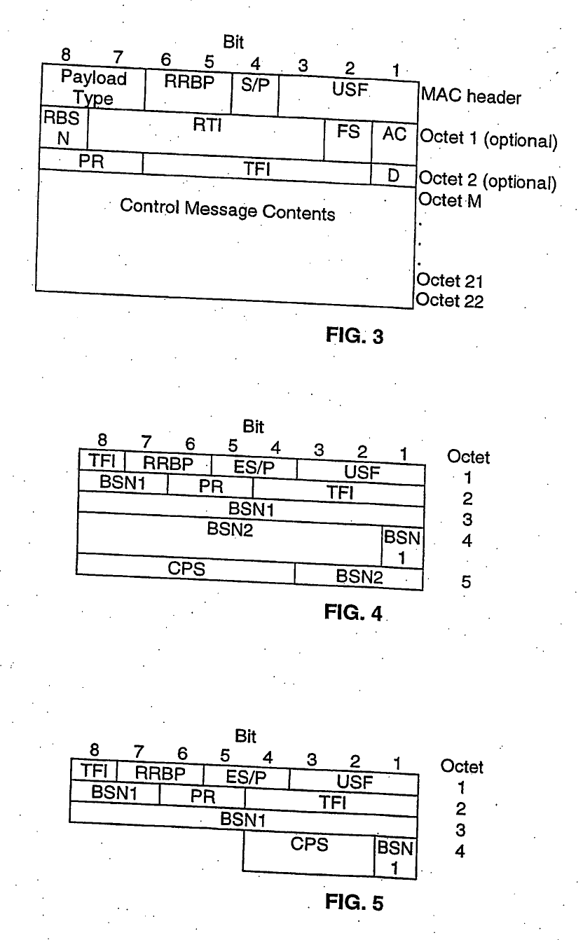

FIG. 3 a format of a GPRS downlink RLC/MAC control block with MAC header;

FIG. 4 a format of an EGPRS downlink RLC data block header for MCS-7, MCS-8, and MCS-9;

FIG. 5 a format of an EGPRS downlink RLC data block header for MCS-5 and MCS-6; and

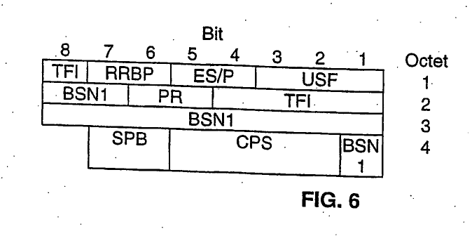

FIG. 6 a format of an EGPRS downlink RLC data block header for MCS-1, MCS-2, MCS-3, and MCS-4.

### METHOD USED WITH GPRS

To detect if a multiuser operation took place at the time of data transmission,
both the RLC data blocks as well as the RLC/MAC control blocks must be evaluated
for the entire lifetime of the respective uplink and/or downlink TBF
on all timeslots allocated to the respective TBF (multislot operation is possible!)
for all TBF's (internal and external!) existing at that time.

This means for the subscriber side measurement system that RLC blocks that do not belong to the internal TBF cannot be disregarded.

The analysis/evaluation system and the corresponding software must include all corresponding information in the analysis, i.e., not only the information belonging to the examined TBF.

Because cells change during a mobile data transmission, this aspect must be taken into consideration in the analysis. Changes in multislot operation as well as in multiuser behavior can be expected after cell changes.

According to the Standard, the function “Delayed TBF” is provided, which is implemented differently depending on the system design and depending if this is an uplink or a downlink.

The contents of the RLC blocks are so-called “Dummy Blocks.” Counting/evaluation in the internal TBF must therefore conclude with the transmission of useful data.

Requirements for Detecting the Situation in the Uplink (Subscriber-Side Measurement System)

The network side distributes/allocates the RLC blocks for the Uplink. The currently employed allocation method is the dynamic allocation method. In this allocation method, the Uplink State Flag (USF) informs the ME about the RLC blocks to be used for the existing TBF.

The USF is located in the MAC header in each RLC data block and in each RLC/MAC control block of the downlink.

The downlink RLC data block together with its MAC header has the format shown in FIG. 2. The USF is described by the first three bits in the MAC header.

The downlink RLC/MAC control block together with its MAC header is illustrated in FIG. 3. The USF is here also described by the first three bits in the MAC header.

Within the context of the TBF establishment-process, a certain USF is associated with a UL-TBF.

For the duration of a UL-TBF, the measurement systems must determine for the timeslots occupied by the TBF, if the network side has allocated other USF's besides those belonging to the established UL-TBF.

The following statements can be made in the context of the measurement/evaluation:
In general, did a multiuser operation take place?
Which timeslots are affected by this multiuser operation?
How many parallel users were in each timeslot?
   Which is the ratio of the number of the internally used RLC blocks to the number of the externally used RCL blocks or to the total number of RLC blocks in the TBF time period?

Requirements for Detecting the Situation in the Downlink (Subscriber-Side Measurement System)

The network side allocates the RLC blocks for the downlink.

In multiuser operation, allocation methods are specific to the employed system design.

A different parameter from the two possible RLC downlink blocks must be evaluated for detecting the behavior in the downlink.

This is the TFI, which is uniquely associated with a (TL-) TBF during the assignment.

Unlike the USF, this parameter is not included in the MAC header, but can instead be included in the RLC header, where it occupies the bits 2-6 in the first octet. Alternatively, it can be included in the RLC/MAC control block, where it occupies the bits 2-6 in the second octet.

As long as data transfer in the DL continues, the ME is required to evaluate each RLC-DL block to determine if this RLC block is intended for the corresponding TBF/TFI. If this is not the case, then this RLC block would be disregarded by the MS.

Within the context of the measurement/evaluation process, it can then again be determined:
In general, did multiuser operation occur?
Which timeslots are affected by this multiuser operation?
How many parallel users were in each timeslot?
   Which is the ratio of the number of the internal the used RLC blocks to the number of the externally used RCL blocks or to the total number of RLC blocks in the TBF time period?

Method Used With Egprs

In general, the same basic principles apply to EGPRS as to GPRS.

The EGPRS data blocks include a RLC/MAC header which contains the corresponding information. Unlike with GPRS, the header format and header types are different depending on the employed modulation and coding schemes (MCS). A differentiation is made between the modulation and coding schemes MCS-1 to MCS-9.

The combined EGPRS downlink RLC/MAC header for the modulation and coding schemes MCS-7, MCS-8, and MCS-9 (header type 1) has the format illustrated in FIG. 4.

The combined EGPRS downlink RLC/MAC header for the modulation and coding schemes MCS-5 and MCS-6 (header type 2) has the format illustrated in FIG. 5.

The combined EGPRS downlink RLC/MAC header for the modulation and coding schemes MCS-1, MCS-2, MCS-3, and MCS-4 (header type 3) has the format illustrated in FIG. 6.

In all header types, the USF is located in the first three bits of the first octet. The TFI includes the first 4 bits of the second octet.

The analysis of the multiuser operation is performed analogous to that for GPRS for the uplink by evaluating the Uplink State Flags (USF) and for the downlink via the Temporary Flow Identifier (TFI).

An example of possible triggering of a data acquisition and evaluation is described below (the description applies to both the subscriber side and the network side):

Triggering for the Uplink

The “classic” setup of an uplink TBF is performed via RACH and PRACH.

The relevant messages are:
CHANNEL_REQUEST (for GPRS /on RACH)
PACKET_CHANNEL_REQUEST (for GPRS /on PRACH)
EGPRS_PACKET_CHANNEL_REQUEST (for GPRS /on RACH or PRACH)

If only the application-controlled data transfer is to be analyzed, then the following information elements (IE) from the above-mentioned messages have to be considered:
Two Phase Access Request and/or Single Block Packet Access
Short Access Request

In EGPRS, the resource request is different depending if a channel with or without 8-PSK modulation is to be provided.

Those RLC data blocks are then relevant for the evaluation, which are transmitted starting with the time, timeslot, and frame specified in the message

PACKET_UPLINK_ASSIGNMENT.

The resource request via the channel: PACCH forms another category.

The relevant message is:
PACKET_DOWNLINK_ACK/NACK with the IE: Channel Request Description.

Resources are allocated by the messages:
PACKET_UPLINK_ASSIGNMENT or PACKET_TIMESLOT_RECONFIGURE.

If “Fixed Allocation” is used in the network, then resources can also be allocated by the message PACKET_UPLINK_ACK/NACK.

The RLC data block, at which the countdown value reaches the value “0” and the transmission/decoding of this RLC block is confirmed with an ACK-message from the network side, is regarded as end point for triggering.

Triggering for the Downlink

Like for the uplink, a “classic” variant exists: by paging.

The relevant messages are here:
PAGING_REQUEST (via PCH)
PACKET_PAGING_REQUEST (via PPCH)

Relevant for the evaluation are then those RLC data blocks, which are transmitted starting with the time, timeslot, and frame specified in the message

PACKET_DOWNLINK_ASSIGNMENT.

If the MS is in the READY State, then the allocation is made only with the message:
PACKET_DOWNLINK_ASSIGNMENT.

Allocation is also feasible via PACCH with the message:
PACKET_TIMESLOT_RECONFIGURE.

The RLC data block, at which the “Final Bit” is set and transmission/decoding of this RLC block is confirmed with an ACK-message from the network side, is regarded as end point for triggering.

The measurement system supports the obtained results with dedicated analyses and evaluations (statistics and visualizations, optionally for multislot, multiuser and/or multi-usage).

### LIST OF REFERENCE SYMBOLS AND ABBREVIATIONS

1 SGSN Serving GPRS Support Node
2 MSC Mobile Switching Center
3 GMSC Gateway Mobile Switching Center
4 PSTN Public Switched Telephone Network
5 GGSN Gateway GPRS Support Node
6 Internet
7 Intranet
8 PCU Packet Control Unit
9 BSC Base Station Controller
10 BTS Base Transceiver Station
11 ME Mobile end station
AUC Authentication Center
BSS Base Station Subsystem (BTS+BSC+PCU)
DL Downlink
EGPRS Enhanced GPRS
GPRS General Packet Radio Service
GSN GPRS Support Node
HLR Home Location Register
LLC Logical Link Control
MAC Medium Access Control
MCS Modulation and Coding Scheme
PSS Packet Switched Subsystem
RLC Radio Link Control
TBF Temporary Block Flow
TFI Temporary Flow Identifier
UL Uplink
USF Uplink State Flag
VLR Visitor Location Register

1-20. (canceled)

21. A method for detecting multiuser behavior on an aerial interface in GPRS and EGPRS mobile radio systems, comprising the steps of
acquiring and evaluating during a transmission of subscriber data on an aerial interface, additional information contained in subscriber data by a device on a network side and/or a subscriber side, both in the uplink and the downlink.

22. The method according to claim 21, further comprising the steps of
comparing at the beginning of a Temporary Bit Flow (TBF) the number of the used Radio Link Control (RLC) blocks with an actually available and hence usable number of RLC blocks, and
identifying a number of parallel subscribers in used timeslots based on the additional information contained in the RLC blocks.

23. The method according to claim 21, further comprising the step of evaluating parameters Uplink Status Flag (USF) and/or Temporary Flow Identifier (TFI) as additional information.

24. The method according to claim 23, further comprising the step of determining for the duration of an uplink TBF, how many USF's are allocated by the network side.

25. The method according to claim 23, further comprising the step of determining for the duration of a downlink TBF, how many USF's are allocated by the network side.

26. The method according to claim 23, further comprising the step of identifying the USF's and/or TFI's and for each TBF and a combination of all TBF's which are part of the transfer.

27. The method according to claim 22, further comprising the step of determining, in a static allocation process, the usage of the timeslots for the RLC blocks by counting the data frames.

28. The method according to claim 21, further comprising the step of evaluating for the entire lifetime of the respective uplink TBF and/or downlink TBF, the RLC data as well as the RLC/MAC control blocks for all TBF's in existence at that time and in all timeslots allocated to the respective TBF, and determining based on these data if a multiuser operation has occurred at the time of the data transmission.

29. A device for detecting multiuser behavior on the aerial interface in GPRS and EGPRS mobile radio systems, wherein during a transmission of subscriber data on the aerial interface, additional information contained in the subscriber data are acquired and evaluated by at least one device on the network side and/or the subscriber side, both in the uplink and the downlink
and wherein the at least one device for acquiring additional information is provided on the network side and/or on the subscriber side in the mobile radio network, which information is included in the subscriber data transmitted on the aerial interface in the downlink and uplink.

30. The device according to claim 29, wherein the at least one device is provided in the Packet Control Unit PCU (8).

31. The device according to claim 29, wherein the at least one device comprises a subscriber-side measurement system, which cooperates with or is integrated in a mobile radio terminal.

32. The device according to claim 29, wherein the additional information comprises the parameters USF and/or TFI.
